(19) United States
(12) Patent Application Publication
(10) Pub. No.: US 2025/0068550 A1
(43) Pub. Date: Feb. 27, 2025

(54) SYSTEM AND METHOD FOR VALIDATING USER-INTERFACE

(71) Applicant: Alkira, Inc., San Jose, CA (US)

(72) Inventors: Santosh Kumar Dornal, San Ramon, CA (US); Sudarvannan Sivakumar, Milpitas, CA (US); Sanchit Lodha, San Jose, CA (US); Veera Raghavendra Prasad Ravinutala, San Ramos, CA (US); Bharath Chakravarthy, San Ramon, CA (US)

(21) Appl. No.: 18/809,364

(22) Filed: Aug. 20, 2024

Related U.S. Application Data
(60) Provisional application No. 63/578,968, filed on Aug. 25, 2023.

(51) Int. Cl. G06F 11/36; G06V 10/74

(52) U.S. Cl. CPC G06F 11/3692; G06F 11/3688; G06V 10/74

(57) ABSTRACT

Provided are a system and a method for validating a user-interface (UI). The system is configured to cause to make a change to a document object model (DOM) of a software application. The DOM of the software application is associated with the UI of the software application. The systems is configured to save the change associated with the DOM, render an updated user interface based on the changed DOM, capture a screenshot of the updated user interface, and validate the updated user interface based on a comparison between the screenshot and a reference image associated with the updated user interface

### TECHNOLOGICAL FIELD

The present invention generally relates to software testing, and more specifically, to validation of a user-interface (UI) of a software application.

### BACKGROUND

A document object model (DOM) of a software product plays a vital role in rendering a user interface of a software product. For example, to change certain aspects of the user interface of the software product, the DOM of the software product may be changed.

Once the software product is developed, software testing may be performed for the software product. In an example, software testing may be performed to examine artifacts, such as elements of the user interface, and behavior of the software product by validation and verification. Software testing may enable evaluation and verification of the software product to check that the software product behaves and performs in a desired manner. Software testing of the software product may be performed to prevent bugs, reduce development costs and improve performance.

### BRIEF SUMMARY OF SOME EXAMPLE EMBODIMENTS

In one aspect, a system for validating a user-interface is provided. The system comprises a processor and a memory coupled to the processor. The memory may have at least one of programs or instructions executable by the processor stored therein. The processor is configured to cause to make a change to a document object model (DOM) of a software application. The DOM of the software application is associated with a user interface of the software application. The processors is configured to save the change associated with the DOM, render an updated user interface based on the changed DOM, capture a screenshot of the updated user interface, and validate the updated user interface based on a comparison between the screenshot and a reference image associated with the updated user interface.

In additional system embodiments, the processor is further configured to identify a set of static features and a set of variable features of the updated user interface, mask the set of variable features from the screenshot of the updated user interface, and perform image matching techniques to compare the screenshot and the reference image.

In additional system embodiments, the processor is further configured to generate a test report for the changed DOM based on the comparison. The test report indicates a similarity value for the screenshot and the reference image.

In additional system embodiments, the reference image is stored in a database.

In another aspect, a method for validating a user-interface is provided. The method comprises causing to make a change to a document object model (DOM) of a software application. The DOM of the software application is associated with a user interface of the software application. The method further comprises saving the change associated with the DOM, rendering an updated user interface based on the changed DOM, capturing a screenshot of the updated user interface, and validating the updated user interface based on a comparison between the screenshot and a reference image associated with the updated user interface.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 shows a network environment in which a system for validating an updated user interface is implemented, according to an example embodiment;

FIG. 2 shows an illustrative environment for managing a validation processes, according to an example embodiment;

FIG. 3 shows a diagram of an example of a computer system, according to an example embodiment;

FIG. 4 shows a block diagram of a system for validating the updated user interface, according to an example embodiment;

FIG. 5 illustrates an example flowchart of a method for validating the updated user interface, according to an example embodiment;

FIG. 6 illustrates an example flowchart of a method for performing a comparison between a screenshot and a reference image of the updated user interface, according to an example embodiment; and

FIG. 7 illustrates an example flowchart of a method for validating the updated user interface, according to an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

Embodiments of the present disclosure provide a system and a method for validating a user interface (UI) of a software application. Typically, conventional software testing tools may interact with the UI of the software application like a user. For instance, the conventional software testing tools may be configured to move a mouse, enter text, click buttons, etc. to interact with the UI. However, an operation of such conventional software testing tools is limited to verification or validation of behavior or output of one or more processes of the software application. To this end, the conventional software testing tools may fail to verify or validate a design or layout of the user interface of the software application.

As may be understood, a document object model (DOM) of the software application provides a programming interface for the software application. The DOM may represent the user interface as, for example, nodes and objects, so that programming languages may interact with the user interface of the software application. For example, as an object-oriented representation of the user interface, the DOM of the user interface may be modified with a programming language such as JavaScript. In this manner, DOM provides an interface for changing or editing entities of the user interface.

However, when a change is made to the DOM of the software application, the user interface of the software application may also change. In certain cases, a change in the DOM of the software application may introduce an unwanted change or a bug in the user interface of the software application. The unwanted change or the bug in the user interface may affect a manner of delivery of information, for example, causing to deliver incorrect information, thereby causing a sense of confusion and potential user frustration. Therefore, such unwanted change in the user interface needs to be identified and addressed.

To overcome the aforementioned problems, the present disclosure provides the system and the method for validating a user interface of a software application.

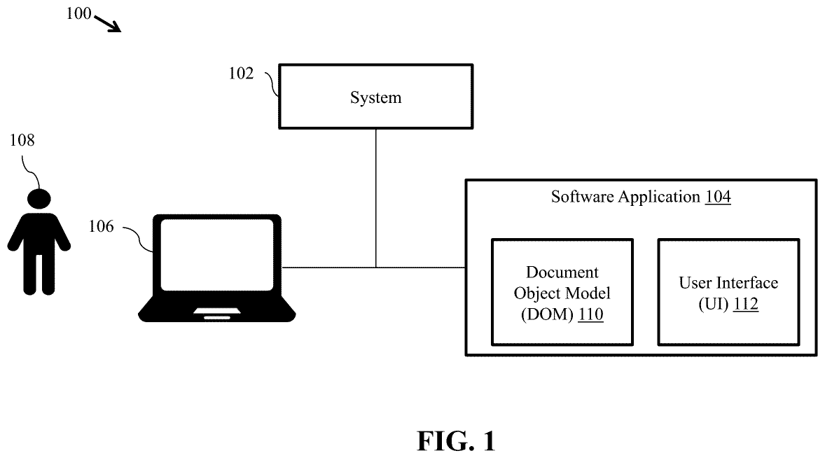

FIG. 1 illustrates a network environment 100 in which a system 102 for validating a user-interface (UI) is operated, according to an example embodiment. The system 102 is configured to validate a UI 112 of a software application 104 that may be installed and/or running on a computing system 106.

In an example, the software application 104 may be a computer program that performs a specific personal, educational, and business function. The software application 104 may be designed to assist end-users in accomplishing a variety of tasks, which may be related to, for example, productivity, creativity, communication, and so forth. The software application 104 may include a plurality of processes, wherein each process may have a sequence of windows, web pages, objects and data elements. Examples of the software application 104 may include, but is not limited to, operating systems, application servers, and other complex software applications. In an example, the software application 104 may be hosted by a remote web server, a cloud network, etc. Further, the software application 104 may be accessed by a user 108, via the computing system 106.

The software application 104 may include a DOM 110 of the software application and the UI 112 of the software application 104. In an example, the user 108 may be a developer associated with the software application 104. For example, the user 108 may access the DOM 110 of the software application 104 in order to make changes. For example, the DOM 110 of the software application 104 may provide an application programming interface to the user 108 for handling UI 112 of the software application 104. In this regard, the user 108 may build a structure of the UI 112, navigate the structure, and add, modify, or delete elements and content of the structure of the UI 112, using the DOM 110 of the software application 104.

Further, the UI 112 of the software application 104 may provide a space or a means for using the software application 104, via the computing system 106. For example, using the UI 112, a user, such as the user 108, and the computing system 106 may interact to execute processes associated with the software application 104. The UI 112 of the software application 104 may enable the user to interact with a backend of the software application 104. The UI 112 of the software application may include, for example, graphical user interface (GUI), natural language interface (NLI), menu-driven interface and form-based interface. The UI 112 may include, for example, menus, buttons, check boxes, drop-down lists, text input boxes, windows, hyperlinks, sliders, search boxes, file-select controls, any other visual graphic representations to be displayed, and other elements of the UI 112 enabling use of various features provided by the software application 104.

The structure of the UI 112 may be stored as documents, such as HTML documents, XHTML documents, etc. The DOM 110 of the software application 104 may represent the document as a tree structure. The DOM 110 may provide an interface to modify, edit or update the structure of the UI 112 of the software application 104. The UI 112 of the software application may be displayed on a display of a computing system, such as the computing system 106. The software application 104 may be in communication with the computing system 106 via a local direct connection or a remote connection such as the Internet, or other suitable connection.

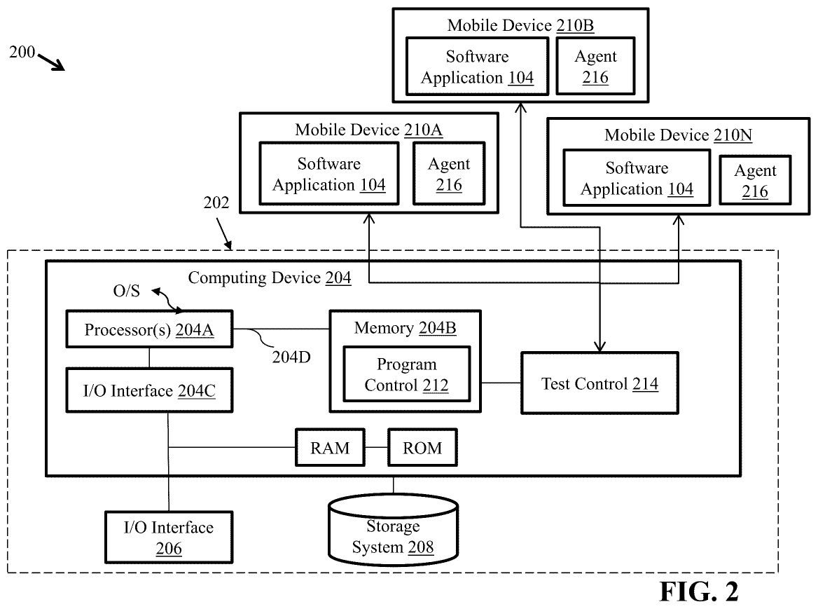

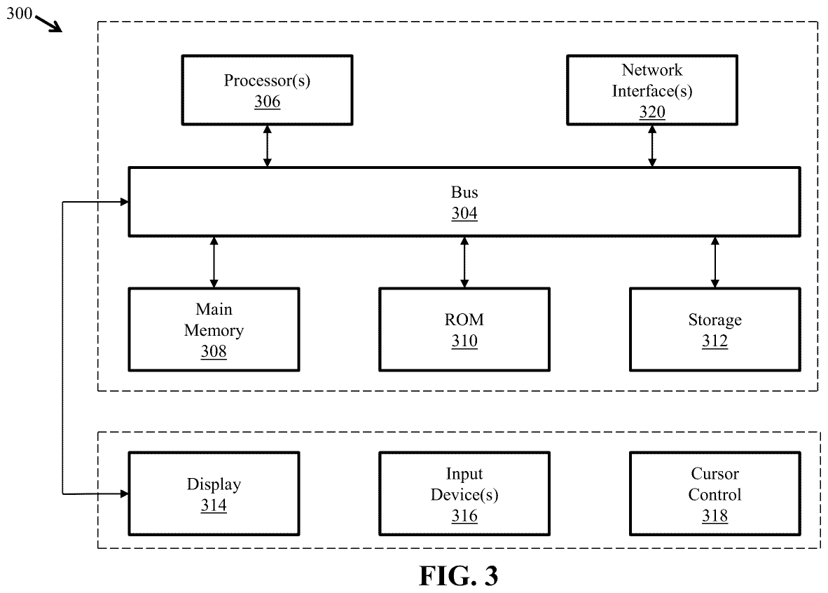

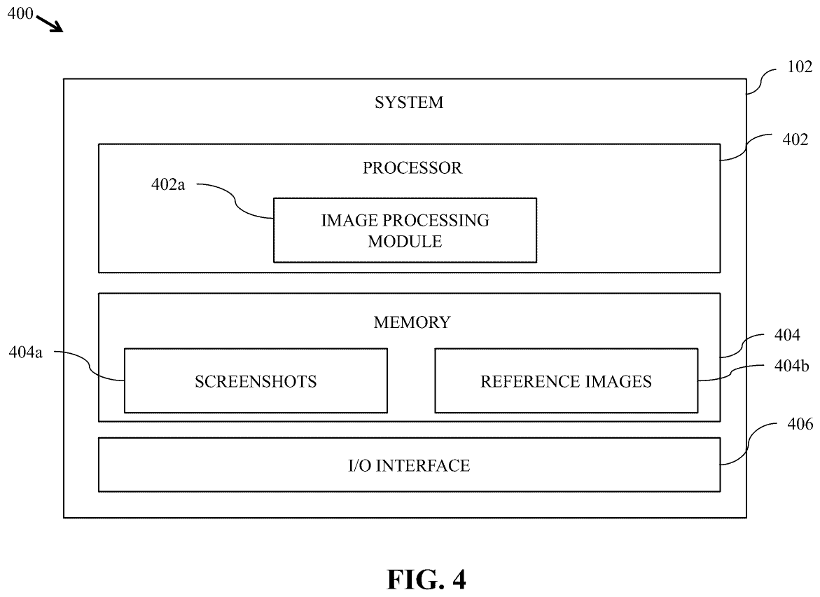

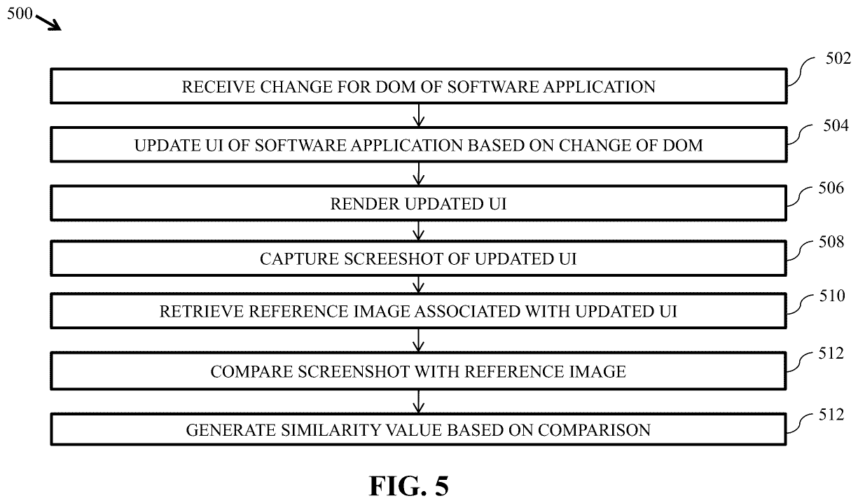

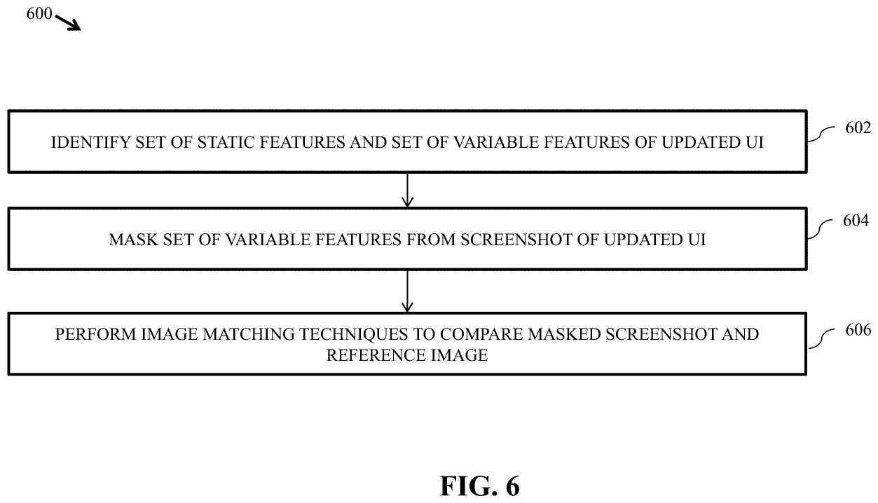

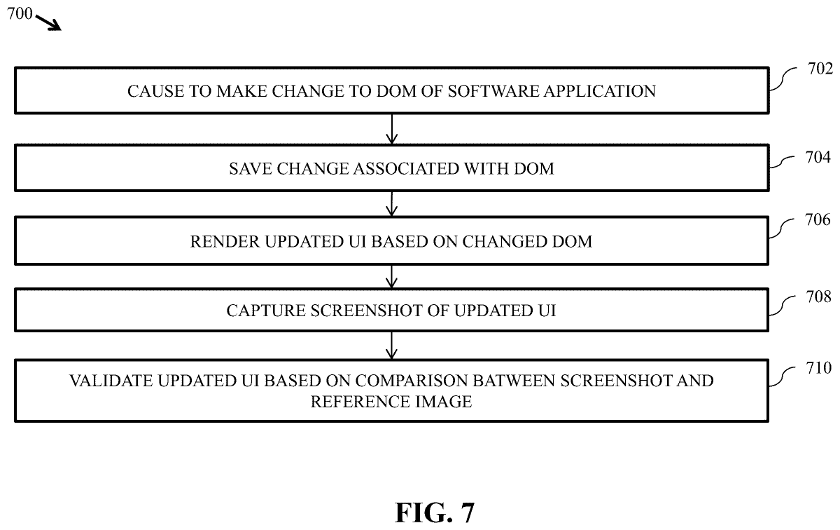

The system 102 is configured to validate or test the UI 112 of the software application 104. Typically, as the user 108 interacts with the DOM 110 of the software application 104, for example, to manipulate the DOM 110 of the software application 104, certain unwanted artifacts or changes may be introduced within the UI 112. Such unwanted artifacts or changes in the UI 112 due to the manipulation of the DOM 110 may usability of the UI 112. Convention software testing tools fail to test a structure and a layout of an updated UI after manipulation of the DOM 110 of the software application 104 to introduce changes and generate the updated UI. A manner in which the system 102 operates to test the updated UI of the software application 104 is described in detail in conjunction with the following FIG. 2, FIG. 3, FIG. 4, FIG. 5, FIG. 6, and FIG. 7.

FIG. 2 shows an illustrative environment 200 for managing a validation processes, in accordance with an example embodiment. The environment 200 includes a server 202 or other computing system. The server 202 may be a test server that is a part of the system 102 used for validating an update of the UI 112 of the software applications 104. In an example, the server 202 may be a standalone server, which implements the operations of the system 102 of the present invention within the networking environment 200. The server 202 and/or processes performed by the server 202 may be integrated into networking environment of any enterprise.

The server 202 includes a computing device 204 which may be resident on a network infrastructure or a physical computing device. The computing device 204 includes a processor 204A (e.g., a CPU), a memory 204B, an I/O interface 204C, and a bus 204D. The bus 204D provides a communications link between each of the components in the computing device 204. In addition, computing device 204 includes a random access memory (RAM), a read-only memory (ROM), and an operating system (OS). The computing device 204 is in communication with an external I/O device 206 and a storage system 208. The external I/O device 206 may include any device that enables an individual to interact with the computing device 204 (e.g., UI) or any device that enables the computing device 204 to communicate with one or more other computing devices using any type of communications link. The storage system 208 may store data such as one or more databases which may be maintained, for example, by an administrator.

The processor 204A executes a computer program code (e.g., a program control 212), which may be stored in the memory 204B and/or the storage system 208. In an example, the program control 212 controls a test control 214 which comprise an application that is adapted to perform one or more processes for validating the update of the UI 112 of the software application 104 described herein. The test control 214 may be implemented as one or more program code in the program control 212 stored in the memory 204B as separate or combined modules. Additionally, the test control 214 may be implemented as separate dedicated processors or a single or several processors to provide the functions described herein. While executing the computer program code, the processor 204A may read and/or write data to/from the memory 204B, the storage system 208, and/or the I/O interface 204C. In this manner, the program code executes the processes of the present disclosure to perform validation of the update of the UI 112 of the software application 104 deployed on devices, such as mobile devices 210a-210n.

According to certain embodiments, the test control 214 communicates with the mobile devices 210a, 210b, . . . , 210n, each of which has a copy of the software application 104 to be tested. As used herein, a mobile device refers to a smartphone, tablet computer, personal digital assistant, or similar device that includes a mobile operating system, wireless communication antenna, processor, UI, memory, etc. In embodiments, an agent 216 resides on each of the mobile devices 210a-210n and reports information about the software application 104 to the test control 214 when the software application 104 is running. More specifically, the agent 216 is configured to “remote control” the corresponding mobile devices 210a-210n, and by adding the agent 216 to the mobile devices 210a-210n it may be possible to capture performance data of the software application 104 running on the mobile devices 210a-210n, and send application information to the computing device 204, e.g., the test control 214. For example, the test control 214 and the computing device 204 may be implemented as or on a testing integrated development environment (IDE). In this way, the agent 216 may be added to the software application 104 that sends native object information to the testing IDE including, for example, screenshots of the UI 112 of the software application 104 deployed on the mobile devices 210a-210n, object information relating to the UI 112 of the software application 104, the mobile device ID, amongst other functionality and features of the software application 104.

In accordance with an example, the test control 214 may use the agent 216 to remotely control the mobile devices 210a-210n for testing purposes. The agent 216 may be one or more test scripts or other suitable test code and may be added to test or validate the software application 104 when a change in the DOM 110 of the software application is compiled and executed.

While the software application 104 is running on one of the mobile devices 210a-210n, the agent 214 sends application information to the test control 214, such as an identification of methods or processes called by the software application 104, data inputs identified by the software application 104 for each process, data outputs associated with each called process, user inputs (e.g., taps, clicks, swipes, etc.), performance data relating to the software application, data relating to the display of the mobile devices 210a-210n, dimensions and locations of UI elements and/or UI objects on the mobile device display screen, information relating to the each UI objects (such as ID, class, visual representation and text), or any combinations thereof.

The program code may include computer program instructions which are stored in a computer readable storage medium. The computer program instructions may also be loaded onto a computer, other programmable data processing apparatus, or other devices to cause a series of operational steps to be performed on the computer. Moreover, any methods provided herein in the form of flowcharts, block diagrams or otherwise may be implemented using the computer program instructions, implemented on the computer readable storage medium.

The computer readable storage medium may be, for example an electronic, magnetic, optical, electromagnetic, infrared, and/or semiconductor system. More specific examples (a non-exhaustive list) would include: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any combination thereof. Accordingly, the computer readable storage medium may be any tangible medium that can contain or store a program for use by or in connection with an instruction execution system, apparatus, or device of the present invention.

FIG. 3 shows a diagram 300 of an example computing system 302, in accordance with an example embodiment. In an example, the computing system 302 may correspond to the computing system 106, the mobile devices 210a-210n, or any other computing device executing the software application 104 to display the UI 112 and/or the DOM 110. In an example, the computing system 302 may be coupled to the system 102, in certain cases, via the agent 216, to enable validation of the UI 112 of the software application 104.

The computing system 302 includes a bus 304 or other communication mechanism for communicating information, one or more hardware processors (referred to as the processor) 306 coupled with the bus 304 for processing information, and a main memory (referred to as the memory) 308 coupled to the bus 304 for storing information and instructions to be executed by the processor 306. The memory 308 may also be used for storing temporary variables or other intermediate information during execution of instructions to be executed by the processor 306. Such instructions, when stored in storage media accessible to the processor 306, render the computer system into a special-purpose machine configured to perform the operations specified in the instructions. Such instructions may be read into the memory 308 from another storage medium, such as the storage device 312. Execution of the sequences of instructions contained in the memory 308 causes the processor 306 to perform process steps, such as those described in this paper, to act as a specially purposed machine.

The computing system 302 further includes, coupled to the bus 304, a read only memory (ROM) 310 or other static storage device, such as a magnetic disk, optical disk, or USB thumb drive (Flash drive), for storing static information and instructions for the processor 306, a display 314, such as a liquid crystal display (LCD) (or touch screen) for displaying information to a computer user, an input device 316, such as a keyboard including alphanumeric and other keys for communicating information and command selections to the processor 306, and a cursor control device 318, such as a mouse, a trackball, cursor direction keys, or other type of input device for communicating information and/or command selections to the processor 306 and for controlling cursor movement on the display 314. Instead or in addition, the same information and command selections as cursor control may be implemented via receiving touches on a touch screen (e.g., of the display 314 or some other device with a screen).

The computing system 302 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component” may refer to logic embodied in hardware or firmware, or to a collection of software instructions, possibly having entry and exit points, written in a programming language, such as, for example, Java, C or C++. An engine may include hardware or firmware. The term “engine,” is not intended to represent a “software engine.” A software component may be compiled and linked into an executable program, installed in a dynamic link library, or may be written in an interpreted programming language such as, for example, BASIC, Perl, or Python. It may be noted that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as the storage device 312. Volatile media includes dynamic memory, such as the memory 308. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise the bus 304. Transmission media can also take the form of acoustic or light waves, such as those generated during radio-wave and infra-red data communications.

The computing system 302 may also include one or more network interfaces (referred to as the communication interface) 320 coupled to the bus 304. The communication interface 320 provides a two-way data communication coupling to one or more network links that are connected to one or more local networks. For example, the communication interface 320 may be an integrated services digital network (ISDN) card, cable modem, satellite modem, or a modem to provide a data communication connection to a corresponding type of telephone line. In another example, the communication interface 320 may be a local area network (LAN) card to provide a data communication connection to a compatible LAN (or WAN component to communicate with a WAN). Wireless links may also be implemented. In such an implementation, the communication interface 320 sends and receives electrical, electromagnetic or optical signals that carry data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic or optical signals that carry digital data streams. The signals through the various networks and the signals on network link and through the communication interface 320, which carry the digital data to and from the computer system, are example forms of transmission media.

In operation, the computing system 302 may send messages and receive data, including program code, through the network(s), network link, and the communication interface 320. In an example, a server might transmit a requested code for an application program through the Internet, the ISP, the local network and the communication interface 320. The received code may be executed by the processor 306 as it is received, and/or stored in the storage device 312, or other non-volatile storage for later execution or playback.

Each of the processes, methods, and algorithms described in the present disclosure may be embodied in, and fully or partially automated by, code components executed by the computing system 302 or computer processors comprising computer hardware. The computing system 302 or computer processors may also operate to support performance of the relevant operations in a “cloud computing” environment or as a SaaS. The processes and algorithms may be implemented partially or wholly in application-specific circuitry. The various features and processes described above may be used independently of one another or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto.

A manner in which the system 102 operates to perform processes for validating the update of the UI 112 of the software application 104 is described in detail in conjunction with FIG. 4, FIG. 5, FIG. 6 and FIG. 7.

FIG. 4 shows a block diagram 400 of the system 102 for validating an update of the UI 112 (referred to as updated UI, hereinafter) of the software application 104, according to an example embodiment. The system 102 may include one or more processor 402, a memory 404 and an I/O interface 406. The embodiments of FIG. 4 are explained in conjunction with FIG. 1, FIG. 2, and FIG. 3.

The one or more processor 402 (referred to as processor 402, hereinafter) may be embodied in a number of different ways. The processor 402 may include an image processing module 402a. The memory 404 may be non-transitory and may include, for example, one or more volatile and/or non-volatile memories. The memory 404 may include screenshots 404a and reference images 404b.

In accordance with an embodiment, the system 102 may store data that may be generated by the processor 402 while performing corresponding operation or data that may be retrieved from a database associated with the system 102, such as a third-party database, etc. In an example, the data may include data relating to the DOM 110, the UI 112, test report based on validating the updated UI, or other data relating to the software application 104, the UI 112, and/or the system 102.

The processor 402 is coupled to the memory 404 and the I/O interface 406. The memory 404 may have stored therein at least one of the programs or instructions executed by the processor 402 to configure the system 102 to perform the automated user-interface validation of the updated UI of the software application 104. The processor 402 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 402 may include one or more processing cores configured to perform independently. A multi-core processor may enable multiprocessing within a single physical package. Additionally or alternatively, the processor 402 may include one or more processors configured in tandem via the bus to enable independent execution of instructions, pipelining and/or multithreading. Additionally or alternatively, the processor 402 may include one or more processors capable of processing large volumes of workloads and operations to provide support for big data analysis. In an example embodiment, the processor 402 may be in communication with the memory 404 and/or the I/O interface 406 via a bus for passing information among components of the system 102.

In an example, when the processor 402 is embodied as an executor of software instructions, the instructions may specifically configure the processor 402 to perform the algorithms and/or operations described herein when the instructions are executed. However, in some cases, the processor 402 may be a processor specific device (for example, a mobile terminal or a fixed computing device) configured to employ an embodiment of the present disclosure by further configuration of the processor 402 by instructions for performing the algorithms and/or operations described herein. The processor 402 may include, among other things, a clock, an arithmetic logic unit (ALU) and logic gates configured to support operation of the processor 402. The network environment, such as, 100 may be accessed using the communication interface of the system 102. The communication interface may provide an interface for accessing various features and data stored in database outside the system 102 and/or the system 102.

For example, the memory 404 may be an electronic storage device (for example, a computer readable storage medium) comprising gates configured to store data (for example, bits) that may be retrievable by a machine (for example, a computing device like the processor 402). The memory 404 may be configured to store information, data, content, applications, instructions, or the like, for enabling the system 102 to carry out various functions in accordance with an example embodiment of the present disclosure. For example, the memory 404 may be configured to buffer input data for processing by the processor 402. The memory 404 may be configured to store instructions for execution by the processor 402.

The memory 404 of the system 102 may be configured to store a dataset (such as, but not limited to, UI data, software application data, web page data, DOM data, and validation data) associated with the software application 104. In accordance with an embodiment, the memory 404 may include processing instructions for processing the software application data. The dataset may include real-time data and historical data relating to the software application 104.

In operation, the processor 404 may be configured to cause to make a change to the DOM 110 of the software application 104. The DOM 110 of the software application 104 is associated with the user interface 112 of the software application 104. For example, the user 110 or a developer of the software application 104 may access the DOM 110 of the software application 104 to make modifications to the user interface 112. The processor 404 may be configured to save the change associated with the DOM 110. In this manner, the user interface 112 may be updated.

Thereafter, the processor 404 may be configured to render the updated user interface based on the changed DOM. For example, the user interface 112 may be updated to change a layout of the UI 112, a layout of UI elements, add or delete certain UI elements, etc. Such update for the UI 112 may be made in the Dom 110. Further, based on the changed DOM 110, the updated UI may be generated. Further, the updated UI may be rendered on a display. In an example, the updated UI may be rendered on the display associated with the computing system 106 which may be used by the user 108 to change the DOM 110. In another example, the updated UI may be rendered on a remote computing device.

Further, the processor 404 may be configured to capture a screenshot of the updated user interface. The processor 402 may capture the screenshot of the rendered updated UI for validation of the updated UI of the software application 104. For example, the screenshot of the updated UI may be stored in the memory 404 as the screenshots 404a.

The processor 402 may be configured to validate the updated user interface based on a comparison between the screenshot and a reference image associated with the updated user interface. For example, the reference image associated with the updated UI may be stored within the memory 404 as the reference images 404b. In an example, the image processing module 402a of the processor 402 may be configured to process the screenshot of the updated UI and the reference image associated with the updated UI to compare the two images. For example, based on the comparison, a determination may be made to check whether the screenshot is similar or same as the reference image or not. In an example, the image processing module 402a may utilize an artificial intelligence-based neural network to compare the screenshot with the reference image associated with the updated UI.

For example, the image processing module 402a may perform image matching techniques to perform matching between, for example, color values, pixel values, etc. between the screenshot and the reference image associate with the updated UI to find the similarities.

Based on the comparison between the screenshot and the reference image associated with the updated UI, the updated UI of the software application 104 may be validated. For example, if the screenshot matched the reference image, i.e., a similarity value between the screenshot and the reference image is high, then the updated UI may be considered to be free of bug or unwanted artifacts.

FIG. 5 illustrates an example flowchart of a method 500 for validating updated UI of the software application 104, according to an example embodiment. The embodiments of FIG. 5 are explained in conjunction with FIG. 1, FIG. 2, FIG. 3, and FIG. 4.

In this regard, at 502, a change associated with the DOM 110 of the software application 104 is received. For example, the change associated with the DOM 110 may be provided by a user, such as developer of the software application 104. The change may include modification for the UI 112 of the software application 104. The change may be saved to update the UI 112.

In an example, using a tree structure, the DOM 110 defines a logical structure of the UI 112 representing UI elements of the UI 112 and a way in which the UI 112 may be accessed and manipulated. For example, events may be assigned to one or more UI elements of the UI 112 of the software application 104 using the DOM 110. These events may be used to perform an operation associated with the corresponding UI elements. Further, the change for the UI 112 may be implemented by making a change in the tree structure defining the structure of the UI 112. For example, the change in the UI 112 may be relating to the structure of the UI 112, structure of the UI elements and/or events associated with the UI elements.

At 504, based on the change, the UI 112 may be updated. The update of the UI may generate an updated UI (not shown). The updated UI may include the change made by the user. For example, when the user edits or modifies processes or features associated with the UI 112 of the software application 104, such edits may be performed in the DOM 110 of the software application 104. In such cases, due to changes in the DOM 110 of the software application 104, a UI of the software application 104 to be displayed on may be affected. For example, the change in the DOM 110 of the software application 104 may cause certain changes in location, color, font, size, orientation or any other type of change in UI elements of the UI. Based on the change the updated UI is generated.

At 506, the updated UI of the software application 104 may be rendered based on the changed DOM. For example, in response to generation of the updated UI, the updated UI may be rendered on a display. The display may be associated with a physical or a remote computing device. The display may be configured to output or display the updated UI present information relating to the updated UI in visual and/or tactile form. Examples of a type of the display may include, but is not limited to, liquid crystal display (LCD), light emitting diode (LED) display, plasma display, electroluminescent display (ELD), thin-film transistor (TFT) LCD, quantum dot LED (QLED) display, organic LED (OLED) display, active matrix organic LED (AMOLED) display, and Super AMOLED display.

At 508, a screenshot of the generated and rendered updated UI of the software application 104 may be captured. In an example, the updated UI is generated based on the modification or change in the DOM 110 of the software application 104.

The screenshot of the updated UI may capture graphical content of the updated UI of the software application 104 being shown on the display of, for example, the computing device 106. For example, the screenshot may include various elements of the updated UI that may be viewed by a user using the software application 104 on their display when the updated UI is displayed. The screenshot may include an image indicating, for example, text, images, buttons, links, input fields, menu, or a combination thereof associate with the updated UI. For example, the screenshot may represent the updated UI in terms of pixel values.

At 510, a reference image associated with the updated UI is retrieved. The reference image may be stored within a database, such as the memory 404 of the system 102. In an example, the reference image may be generated manually or automatically, for example, during a designing of the updated UI during product development cycle.

At 512, a comparison is performed between the screenshot of the updated UI and a reference image of the updated UI. The screenshot of the updated UI may indicate actual structure and/or layout of the updated UI of the software application 104 that may be displayed on the display, whereas the reference image associated with the updated UI may indicate a desired structure and/or layout of the updated UI of the software application 104. For example, the screenshot of the updated UI and the reference image of the updated UI may be compared based on image processing techniques. In an example, pixel values of the screenshot and the reference image of the updated UI may be compared to compare the two images.

Further, the processor 402 may be configured to compare the screenshot with the reference image for the updated UI to determine a level of similarity between the generated updated UI of the software application 104 and desired updated UI for the software application 104. The level of similarity may indicate if the generated updated UI after the applied change is same as desired or not.

At 514, a similarity value is generated based on the comparison. For example, the similarity value may indicate a level of similarity between the screenshot of the updated UI and the reference image of the updated UI. In an example, pixel values of the screenshot may be compared with pixel values of the reference image. For example, a difference may be determined between a first pixel value of a first pixel location within the screenshot and a second pixel value of the first pixel location within the reference image. Further, if the difference may be higher than a difference threshold then the first pixel value may vary from the second pixel value, resulting is a low similarity value for the first pixel location. In an example, based on similarity values for different pixel locations, an overall similarity value may be determined for the updated UI comparison of the screenshot and the reference image.

In certain cases, a test report may be generated for the updated UI based on the comparison between the screenshot and the reference image of the updated UI. The test report may include the similarity value for the updated UI. In an example, the test report may also indicate one or more identified area or pixel locations that may have a similarity value less than the difference threshold.

In an example, the generated test report and/or the similarity value may be provided to a user, such as a developer of the software application 104 for changes or corrections to the DOM 110.

FIG. 6 illustrates an example flowchart of a method 600 for performing a comparison between a screenshot of updated UI and the reference image, in accordance with an example embodiment. The embodiments of FIG. 6 are explained in conjunction with FIG. 1, FIG. 2, FIG. 3, FIG. 4 and FIG. 5.

At 602, a set of static features and a set of variable features of the updated UI are identified. In an example, the processor 402 and/or the image processing module 402a may be configured to determine the set of static features and the set of variable features. It may be noted that any change in parameters or values associated with the set of static features may be undesirable, whereas values of the set of variable features may change during execution of the software application 104. Examples of the set of static features may include, but is not limited to, font, design, format, field parameters (such as “name”, “email”, “contact”, “user id”, etc.), a logo, an graphical icon, and the like. Examples of the set of variable features may include user-specific values, such as value of name, value of email, value of contact information, value of user id, etc.

At 604, the set of variable features are masked from the screenshot of the updated UI. The masking of the set of variable features may ensure privacy of a user that may be using or executing the software application 104 as well ensure effective and reliable output of comparison between the screenshot and the reference image.

It may be noted that the screenshot of the updated UI may be masked to edit the screenshot image in a non-destructive way. Image masking techniques may hide the variable features or portion of screenshot indicating the variable features within the screenshot of the updated UI

At 606, image matching techniques are performed to compare the masked screenshot and the reference image. The screenshot and the reference image are compared to determine a similarity value between the screenshot and the reference image of the updated UI. Moreover, a test report may be generated based on the similarity value. The test report may be utilized to modify the DOM 110 of the software application 104 to correct any errors, bugs or unwanted artifacts in the updated UI of the software application 104.

FIG. 7 illustrates a flowchart of an example method 700 for validating the updated UI of the software application 104, in accordance with an example embodiment. The embodiments of FIG. 7 are explained in conjunction with FIG. 1, FIG. 2, FIG. 3, FIG. 4, FIG. 5 and FIG. 6.

At 702, a change is made to the DOM 110 of the software application 104. The change to the DOM 110 is made by a user, such as a developer or a programmer of the software application 104. The DOM 110 of the software application 104 is associated with the user interface 112 of the software application 104.

At 704, the change associated with the DOM 110 is saved. The change to the DOM 110 may generate an updated UI.

At 706, the updated UI is rendered based on the changed DOM 110. The updated UI may be rendered on a display.

At 708, a screenshot of the updated UI is captured. The screenshot may be edited to mask a set of variable features of the updated UI in the screenshot.

At 710, the updated UI is validated based on a comparison between the screenshot and a reference image associated with the updated UI. For example, pixel values of the screenshot and the reference image are compared to identify differences between the screenshot and the reference image, i.e., a layout of the rendered updated UI and a desired layout of the updated UI.

In this manner, based on a comparison between the screenshot of the generated updated UI the software application and corresponding reference image, the updated UI of the software application is validated. Based on real-time validation of the updated UI of the software application, corrected UI may be simultaneously generated to overwrite a version of the updated UI having unwanted artifacts. This may ensure that information on the updated UI of the software application are correctly represented and prevent any incoherent interaction between the unwanted artifacts of the updated UI of the software application and a user.

Accordingly, blocks of the methods 300, 400 and 500 support combinations of means for performing the specified functions and combinations of operations for performing the specified functions for performing the specified functions. It will also be understood that one or more blocks of the methods 300, 400 and 500, and combinations of blocks in the methods 300, 400 and 500, can be implemented by special purpose hardware-based computer systems which perform the specified functions, or combinations of special purpose hardware and computer instructions.

Alternatively, the system 102 may comprise means for performing each of the operations described above. In this regard, according to an example embodiment, examples of means for performing operations may comprise, for example, the processor 402 and/or a device or circuit for executing instructions or executing an algorithm for processing information as described above.

On implementing the methods 300, 400 and 500 disclosed herein, the end result generated by the system 102 is a tangible validated or verified updated UI of a software application, wherein such validated UI may be displayed to improve user experience, reduce confusion, etc.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a processor;
a memory coupled to the processor, the memory having stored therein at least one of programs or instructions executable by the processor to configure the system to:
cause to make a change to a document object model (DOM) of a software application, the DOM of the software application being associated with a user interface of the software application;
save the change associated with the DOM;
render an updated user interface based on the changed DOM;
capture a screenshot of the updated user interface; and
validate the updated user interface based on a comparison between the screenshot and a reference image associated with the updated user interface.

2. The system of claim 1, wherein, to perform the comparison between the screenshot of the updated user interface and the reference image, the processor is further configured to:
identify a set of static features and a set of variable features of the updated user interface;
mask the set of variable features from the screenshot of the updated user interface; and
perform image matching techniques to compare the screenshot and the reference image.

3. The system of claim 1, wherein the processor is further configured to:
generate a test report for the changed DOM based on the comparison, the test report indicating a similarity value for the screenshot and the reference image.

4. The system of claim 1, wherein the reference image is stored in a database.

5. A non-transitory computer readable storage medium, having stored thereon, a set of computed-executable instructions that causes a computer to perform a method, comprising:
causing to make a change to a document object model (DOM) of a software application, the DOM of the software application being associated with a user interface of the software application;
saving the change associated with the DOM;
rendering an updated user interface based on the changed DOM;
capturing a screenshot of the updated user interface; and
validating the updated user interface based on a comparison between the screenshot and a reference image associated with the updated user interface.

6. The non-transitory computer readable storage medium of claim 5, wherein performing the comparison between the screenshot of the updated user interface and the reference image comprises:
identifying a set of static features and a set of variable features of the updated user interface;
masking the set of variable features from the screenshot of the updated user interface; and
performing image matching techniques to compare the screenshot and the reference image.

7. The non-transitory computer readable storage medium of claim 5, further comprising
generating a test report for the changed DOM based on the comparison, the test report indicating a similarity value for the screenshot and the reference image.

8. The non-transitory computer readable storage medium of claim 5, wherein the reference image is stored in a database.

9. A method, comprising:
causing to make a change to a document object model (DOM) of a software application, the DOM of the software application being associated with a user interface of the software application;
saving the change associated with the DOM;
rendering an updated user interface based on the changed DOM;
capturing a screenshot of the updated user interface; and
validating the updated user interface based on a comparison between the screenshot and a reference image associated with the updated user interface.

10. The method of claim 9, wherein performing the comparison between the screenshot of the updated user interface and the reference image comprises:
identifying a set of static features and a set of variable features of the updated user interface;
masking the set of variable features from the screenshot of the updated user interface; and
performing image matching techniques to compare the screenshot and the reference image.

11. The method of claim 10, further comprising
generating a test report for the changed DOM based on the comparison, the test report indicating a similarity value for the screenshot and the reference image.

12. The method of claim 11, wherein the reference image is stored in a database.
